(19) United States
(12) Patent Application Publication
(10) Pub. No.: US 2002/0089670 A1
(43) Pub. Date: Jul. 11, 2002

(54) Photodetector for ring laser gyros

(76) Inventor: Douglas P. Mortenson, Maple Grove, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 09/920,687

(22) Filed: Aug. 2, 2001

Related U.S. Application Data
(60) Provisional application No. 60/224,698, filed on Aug. 11, 2000.

(51) Int. Cl. G01C 19/66

(52) U.S. Cl. 356/468

(57) ABSTRACT

A photodiode is formed with an integral mask so as to be able to undesirable light. By forming the mask directly on the photodiode instead of etching the mask on a cover, or placing a mask on the cover, misalignment problems can be avoided.

### REFERENCE TO RELATED APPLICATION

This application claims the benefit of U.S. Provisional Application Serial No. 60/244,698 filed on Aug. 11, 2000 and entitled “Photomask Directly On Photodetector” which is incorporated herein by reference.

### PHOTODETECTOR FOR RING LASER GYROS

1. Technical Field

This invention relates to the field of photodetectors and more particularly to photodetectors used with lasers.

2. Background of the Invention

Examples of ring laser gyroscopes are shown and described in U.S. Pat. No. 3,373,650 issued to J. Killpatrick and U.S. Pat. No. 3,390,606 issued to T. Podgorski. An integral part of a ring laser gyro is the laser beam source or generator. One type of laser generator comprises electrodes and a gas discharge cavity in combination with a plurality of mirrors that establishes an optical closed loop path. A laser block having a plurality of interconnecting tunnels or bores generally forms the gas discharge cavity.

Present day ring laser gyros employ a gas discharge cavity filled with a lasing gas which is ionized when excited by an electric current passing from one electrode to another through the lasing gas. If the plurality of mirrors is properly aligned, two counter-propagating laser beams will be established, traveling in opposite directions along the optical closed loop path. Each counter-propagating laser beam may consist of several light beams sometimes referred to as spatial modes. The centermost mode, commonly referred to as the TEM₀₀ mode (and also referred to as the fundamental or primary spatial mode), contains the greatest amount of energy and is of greatest value to the operation of the ring laser gyro.

One embodiment of a ring laser gyro system includes a device called a path length controller that is capable of making slight alterations to the length of the optical closed loop path by changing the distance between the plurality of mirrors. To ensure that the path length is properly set, a laser intensity monitor (LIM) is appropriately coupled to the discharge cavity in order to observe the intensity of a portion of one of the counter-propagating laser beams exiting through one of the plurality of mirrors. Desirably, the laser intensity monitor should be sensitive to only the TEM₀₀ mode of the laser beam exiting the mirror. Based on the intensity of the TEM₀₀ mode, the path length is regulated so that the TEM₀₀ mode always contains the maximum amount of energy possible.

To achieve this, only the TEM₀₀ mode of one of the counter propagating laser beams is monitored. If more than one spatial mode was monitored simultaneously, the ring laser gyro might attempt to adjust the path length so as to maximize the energy in a mode other than the TEM₀₀ mode. This would cause the ring laser gyro to give less precise readings, than if only the TEM₀₀ mode was

FIG. 1 illustrates a method of employing a photodetection laser intensity monitoring apparatus 10 as part of a ring laser gyroscope. As described earlier, a laser block 30 along with a plurality of mirrors including mirror 202 provides a pair of counter-propagating laser beams 35 and 36 as particularly described in U.S. Pat. No. 3,390,606 issued to T. Podgorski.

As illustrated in FIG. 1, optically transmissive substrate 200 is fixed to block 30. Transmissive substrate 200 includes opposite major surfaces 201 and 216. First major surface 201 is suitably polished and optically coated to provide a partially transmissive mirror 202 for reflecting a major portion of beam 36, in a direction opposite of beam 35. Similarly, a major portion of beam 35 is reflected in the direction opposite of beam 36.

Also illustrated in FIG. 1, the laser intensity monitoring apparatus 10 in accordance with the present invention is comprised of a photodetector package 11 for hermetically enclosing or environmentally protecting a photodetector 12 having a photosensitive element or surface 20. The photodetector package includes an opaque rigid, cup-shaped enclosure 14 and an optically transparent window 16 having first and second opposite surfaces 401 and 402, respectively, which form in part an interior surface and an exterior surface of the photodetector package, respectively. Further, window 16 includes a thin film nonreflective metallic mask 24 deposited on the surface 402 of window 16. As will be more fully described, thin film nonreflective metallic mask 24 illustrated in FIG. 5 is substantially opaque and includes an aperture 100 of a selected size and shape for passing light therethrough.

The photodetector package 11 is rigidly fixed to substrate 200 such that transparent window 16 is juxtaposed to surface 216. With photodetector package 11 and aperture 100 of mask 24 properly aligned, light beams transmitted through mirror 202 and emerging therefrom will pass through transparent window 16 and aperture 100 to impinge upon the photosensitive surface 20 of photodetector 12.

As a result of mask 24, only the TEM₀₀ mode light from one of the counter-propagating laser beams, e.g. beam 35, as illustrated in FIG. 1, is allowed to impinge upon photosensitive surface 20 of photodetector 12. As the intensity of the TEM₀₀ mode light of the impinging beam changes, photodetector 12 will vary its output accordingly.

FIG. 2 illustrates an alternate embodiment of laser intensity monitoring apparatus 10 of the present invention. The embodiment of FIG. 2 has components of FIG. 1 with the same numerical designations. The embodiment illustrated in FIG. 2 is identical to the embodiment described in FIG. 1 except that the thin film nonreflective metallic mask 24 is deposited on surface 402 of transparent window 16, instead of surface 401. Although the thin film mask 24 is illustrated as covering the whole window, it is not required to effect proper bonding to substrate 200.

Heretofore, a laser intensity monitoring apparatus consisted of a photodetector contained within a package that comprised an enclosure in which the photodetector is mounted. The enclosure further included a transparent window generally parallel to, and in front of, the photosensitive surface of the photodetector. A mylar mask is attached to the outer surface of the transparent window with an adhesive. The mylar mask is similar to a photographic negative that is generally opaque with an aperture of a size and shape that will only allow the TEM₀₀ mode to pass through. Alternatively, glass masks placed between the impinging light and the photodetector were used.

Photodetectors incorporated into ring laser gyros include the readout detector and LIM detector. The assemblies into which these devices are mounted can include masks for blocking portions of the optical signals applied to the detectors. The readout detector assembly, for example, can include a mask in the form of a grid pattern.

One known approach for incorporating masks into readout detector assemblies includes the use of chrome masks pattered onto mylar or glass. The mask is bonded between the photodetector package and the ring laser gyro mirror. These approaches have a number of drawbacks. Glass masks are relatively expensive. Although less expensive than glass masks, the mylar masks do not perform as well over temperature ranges. Several different grid sizes are used, so masks of several sizes have to be inventoried. It can also be somewhat time consuming to align and bond the masks to the photodetector package during assembly.

Another approach involves patterning the mask directly on the clear sapphire lid of the photodetector package. Many of the drawbacks associated with the need to manufacture, inventory and assemble the separate masks are reduced with this approach. However, it is relatively expensive to manufacture the lids with the masks, and they are prone to scratching during assembly.

### SUMMARY OF THE INVENTION

The invention is a photodetector for ring laser gyros (e.g., readout detectors and LIM detectors), having a mask formed directly on the photodetector die. The mask is formed through semiconductor manufacturing process such as spinning, printing, spraying or vacuum deposition. A preferred material for forming the mask is blue chrome applied through a sputtering process. Such a construction is usable for both laser readout devices and the LIM.

Although described above in connection with the readout detector, the invention can also be incorporated into the LIM detector Photodetectors in accordance with the invention offer a number of advantages. Since the mask is on the die, its susceptibility to scratching is reduced. Costs can be reduced due to the high degree of process integration that can be achieved. Also, since a relatively high degree of alignment accuracy can be achieved, more complex mask patterns can be efficiently incorporated into the devices.

### BRIEF DESCRIPTION OF THE DRAWINGS

FIG. 1 is a cross sectional view of a prior art ring laser gyroscope illustrating one embodiment of a prior art laser intensity monitor readout using a mask.

FIG. 2 is a cross sectional view of a prior art ring laser gyroscope illustrating another embodiment of a prior art laser intensity monitor readout using a mask.

FIGS. 3 and 4 are illustrations of dual aperture grid-type masks on dies in accordance with the present invention.

FIG. 5 is an illustration of an aperture-type mask that can be incorporated into a LIM photodetector.

FIG. 6 is a plan view of a pair of detectors on the same die with a mask formed thereon.

FIG. 6A is a schematic diagram of the photodetector of FIG. 6. FIG. 6B shows the physical structure of the photodetector under the photomask.

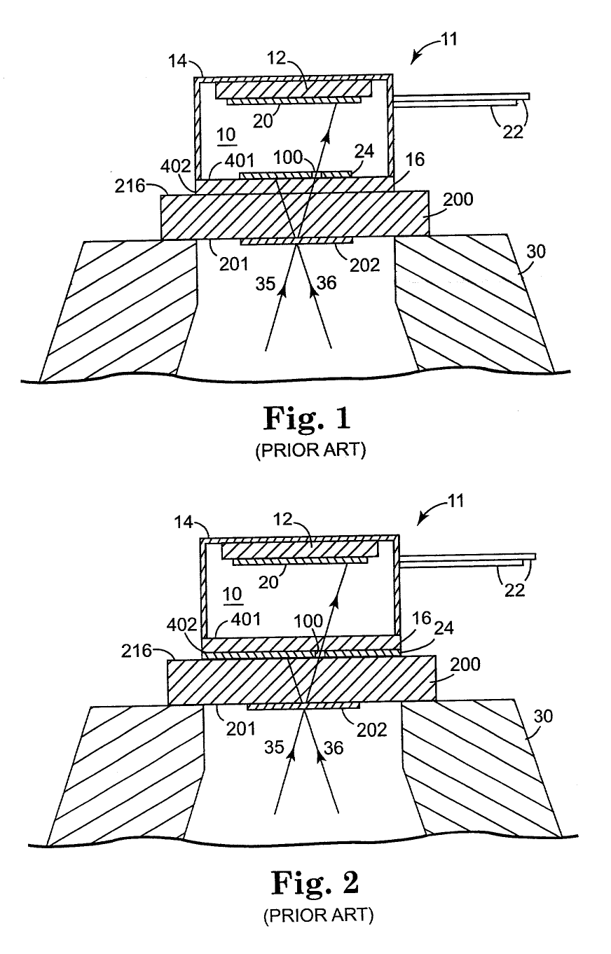

### DETAILED DESCRIPTION OF THE INVENTION

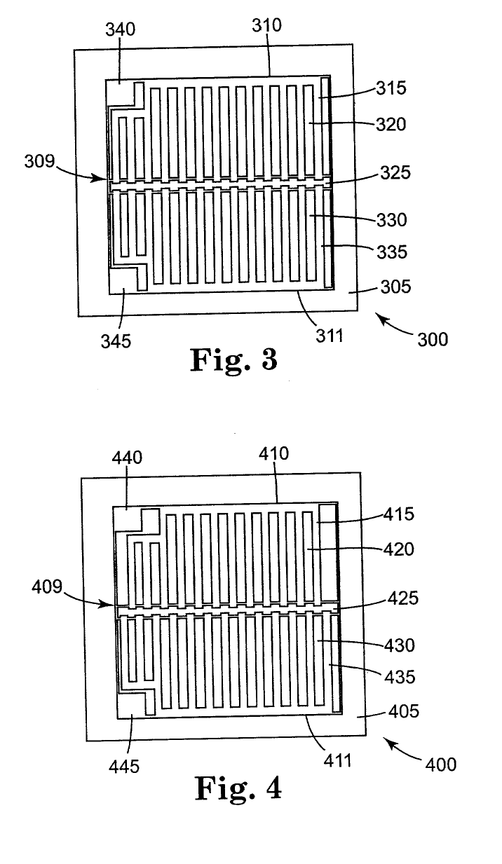

Referring now to FIG. 3, thereshown is a photodetector 300 of the present invention for use as a readout detector. Photodetector 300 includes die 305, mask 309 and wire bond pads 340 and 345. Mask 309 has two regions 310 and 311 which create a pattern on die 305 such that regions 320 and 330 are left uncovered by the mask so that light may hit the die and thereby affect its conductivity. Mask bars 315 are formed on the die through a process such as spinning, printing, spraying or vacuum deposition. In a preferred embodiment, the mask is made from blue chrome applied to a wafer of photodetectors using a sputtering process. If the photomask poses a contamination problem for the photodetector, an additional topcoat can be applied to the wafer prior to masking. After the photodetectors have been masked, the wafer is cut into individual photodetectors.

Referring now to FIG. 4, thereshown is a photodetector 400 similar to the photodetector of FIG. 3. In the present photodetector however, the mask 409 has two regions 410 and 411 that are offset so that bars 415 on mask 410 line up with uncovered regions 430 and bars 435 line up with uncovered regions 420.

Following the application of the photo mask material, the photodetector manufacturer can etch the desired mask pattern into the material using photo etch processes. Wire bond pads can be etched away from the area adjacent to the traces. The individual dies can then be cut from the wafer

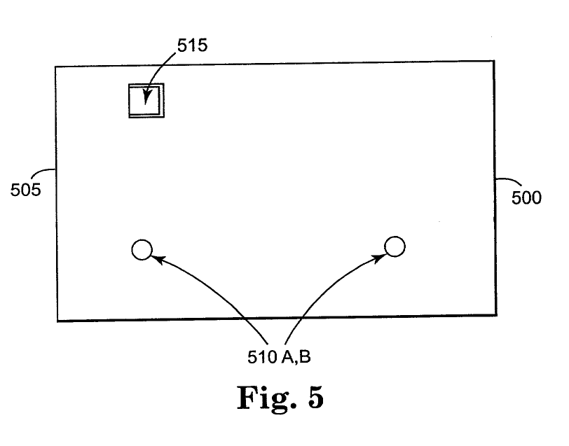

Referring now to FIG. 5, thereshown is a laser intensity monitor mask for path length control. The mask 501 includes apertures 510A and B. The apertures are sized so as to let through light at the TEM₀₀ mode. A bond pad opening 515 is made through the mask to reach the bond pad. It is formed so as to be able to connect wires to the photodetector.

For both the readout and LIM, in a preferred embodiment, the photodetector has a mask with chrome metallization at 5% maximum reflected light at 6328 Angstroms. The chrome mask shall have optical density units of 2.5 or greater (0.3% transmission or less). The coated optical surface should not show evidence of coating removal when cellophane tape is pressed firmly against the coated surface and quickly removed at an angle normal to the coated surface. Diffuse transmission densitometry readings should fall between 0.26 and 0.35 density units. For the readout, the ratio of clear to dark width should be between 0.8182 and 1.2222.

In another preferred embodiment of a readout sensor, photosensor gridlines will be patterned with a non-reflective blue chrome process applied directly to the bi-cell photosensor. The pitch of the birefringent pattern determines the pitch of the grid lines. Here, the grid lines are 0.0010 inch to 0.0024 inch in 0.00006 inch steps. Metalization reflectivity is at a minimum at 6328 angstroms. Optical density of 2.5 (0.3% maximum transmission) with grid lines perpendicular to two active areas within 5%. Finally a dark to light ratio is established at 50:50±3%.

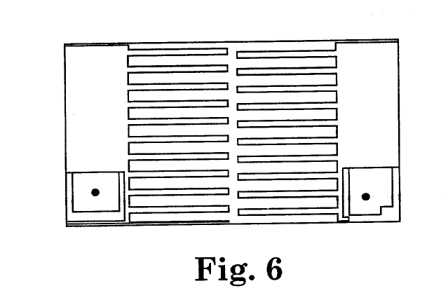

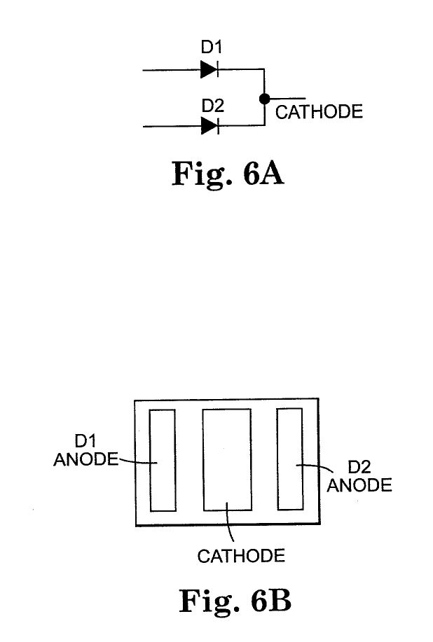

Referring now to FIG. 6A, thereshown is a schematic diagram of the photodetector of the present invention. Two diodes, D1 and D2 are connected together at their cathodes. FIG. 6B shows a plan view of a die containing the two diodes.

The photodetector component of devices in accordance with the invention can be fabricated using conventional or otherwise known processes. One manufacturer of these devices is Semicoa of Costa Mesa, Calif. If the material from which the mask is manufactured is one that can contaminate the photodetector component, an additional topcoat can be applied to the wafer before the mask is deposited.

Before the wafer is sawed into individual devices, the photo mask material can be applied to the entire surface of the wafer. The photomask material can be applied by spinning, printing, spraying, or vacuum deposition processes. In one embodiment of the invention, the photo mask material is blue chrome applied to the wafer by a sputtering process. One source for this photo mask material deposition is Telic of Culver City, Calif. The material selected for the mask will typically depend upon a number of factors including the reflection requirements, the temperatures to which the material is exposed during manufacture and use, and process capabilities of the manufacturer.

Following the application of the photo mask material, the photodetector manufacturer can etch the desired mask pattern into the material using photo etch processes. A hole in the mask can be etched to reach the wire bond pads and thereby enable wirebonding. If the mask material is electrically conductive and there are other metal traces on the device surface, the mask material should also be etched away from the area adjacent to the traces. The photodetector manufacturer can then saw the individual dies from the wafer and assemble them into the next level of packaging.

While the present invention has been disclosed in connection with the preferred embodiment thereof, it should be understood that there may be other embodiments which fall within the spirit and scope of the invention as defined in the following claims.

What is claimed is:

1. A photodetector, comprising:
a) a pair of diodes formed in common on a shared die;
b) a mask formed integrally with the die.

2. The photodetector of claim 1, wherein:
a) the mask is formed with parallel bars of an opaque material with gaps there between.

3. The photodetector of claim 2, wherein:
a) the parallel bars are formed in two groups, a first group positioned to cover the first diode and a second group positioned to cover the second diode, each group having spaced bars having a distal end, the distal ends of one group being positioned adjacent to a gap between bars of the other group.

4. The photodetector of claim 1, wherein:
a) the mask is formed with a plurality of substantially circular apertures formed therein.

5. The photodetector of claim 1, wherein:
a) the apertures are sized to allow only TEM₀₀ light therethrough.

6. The photodetector of claim 1, wherein:
a) the pitch of the parallel lines match the pitch of the birefringent pattern

7. A method of making a masked photodetector, comprising:
a) forming a die with a diode formed therein;
b) placing a photomask on the die to cover a portion of the diode.

8. The method of claim 7, further comprising the steps of:
a) forming the photomask to have a plurality of parallel bars of optically opaque material with a gap formed between bars, the bars and gap having a width.

9. The method of claim 8, further comprising the step of:
a) forming the bars and gap to have a width such that a ratio of the width of a gap to the width of a single bar is between 0.8182 and 1.2222.

10. The method of claim 9, further comprising the step of:
a) forming the bars from a blue chrome material.

11. The method of claim 6, further comprising the step of:
a) forming the mask to have a plurality of apertures therein, one of said apertures being positioned to allow light to reach the diode.

12. The method of claim 11, further comprising the step of:
a) forming the aperture to allow only light having a TEM₀₀ to pass therethrough.

13. A ring laser gyro readout detector, comprising:
a) a first photodiode
b) a mask formed in the photodiode for excluding certain wavelengths of light from reaching the photodiode.

14. The ring laser gyro readout of claim 13, wherein the mask further comprises:
a) a plurality of substantially planar, spaced parallel bars formed on the photodiode, the spacing being selected to match the pitch of the birefringent pattern.

15. The ring laser gyro readout of claim 14, further comprising a second photodiode.

16. The ring laser gyro readout of claim 15 wherein the first and second diodes are formed side by side on a die with a central gap therebetween.

17. The ring laser gyro readout of claim 16, wherein the mask covers both diodes.

18. The ring laser gyro readout of claim 17, wherein the bars of the mask are formed in first and second groups, the first group being positioned adjacent to the first photodiode, the second group being positioned adjacent to the second photodiode.

19. The ring laser gyro readout of claim 18, wherein the first and second groups are connected by a mask edge and wherein the bars of each group have a distal end adjacent to the central gap.

20. The ring laser gyro readout of claim 19, wherein the distal end of the bars of the first group are positioned to be adjacent to spaces between bars of the second group.
